(19) United States
(12) Patent Application Publication
(10) Pub. No.: US 2026/0330595 A1
(43) Pub. Date: Oct. 22, 2026

(54) CONTEXT AWARE SPATIALLY VARYING KERNEL

(71) Applicant: QUALCOMM Incorporated, San Diego, CA (US)

(72) Inventors: Ashish MENON, Bangalore (IN); Shubham Maroti DHAGE, Bangalore (IN); Shireesh KADARAMANDALGI, Bengaluru (IN); Banuprasad BATHALA, Srikalahasti (IN); Anurag JAIN, Bengaluru (IN); Pawan Kumar BAHETI, San Diego, CA (US)

(21) Appl. No.: 19/184,915

(22) Filed: Apr. 21, 2025

(51) Int. Cl. G06T 3/4046; G06T 5/20; G06T 5/50; G06T 5/60; G06T 5/70

(52) U.S. Cl. CPC G06T 3/4046; G06T 5/20; G06T 5/50; G06T 5/60; G06T 5/70; G06T 2207/20084

(57) ABSTRACT

Systems and techniques are described for image processing. For example, a computing device can obtain a downscaled image of a scene. The downscaled image is generated based on downscaling an image having a first resolution. The downscaled image including a second resolution that is lower than the first resolution. The computing device can generate, using a kernel prediction network based on the downscaled image, kernel parameters and a downscaled kernel associated with the second resolution. The downscaled kernel includes a plurality of downscaled kernel weights and is associated with an application. The computing device can generate, based on the downscaled kernel and the kernel parameters, a kernel associated with the first resolution. The kernel includes a plurality of weights and is associated with the application. The computing device can generate an output image based on the kernel and the image.

### FIELD

The present disclosure generally relates to image processing. For example, aspects of the present disclosure relate to system designs and methods for image processing using a context aware spatially varying kernel.

### BACKGROUND

The increasing versatility of digital camera products has allowed digital cameras to be integrated into a wide array of devices and has expanded their use to different applications. For example, phones, drones, cars, computers, televisions, and many other devices today are often equipped with camera devices. The camera devices allow users to capture images and/or video (e.g., including frames of images) from any system equipped with a camera device. The images and/or videos can be captured for recreational use, professional photography, surveillance, and automation, among other applications. Moreover, camera devices are increasingly equipped with specific functionalities for modifying images or creating artistic effects on the images. For example, many camera devices are equipped with image processing capabilities for generating different effects on captured images. Recently, there has been an increase in popularity of modifying and introducing effects into images or into video including a plurality of images.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems and techniques for image processing. In some aspects, an apparatus for image processing is provided. The apparatus includes at least one memory and at least one processor coupled to the at least one memory and configured to: obtain a downscaled image of a scene, wherein the downscaled image is generated based on downscaling an image having a first resolution, the downscaled image including a second resolution that is lower than the first resolution; generate, using a kernel prediction network based on the downscaled image, kernel parameters and a downscaled kernel associated with the second resolution, wherein the downscaled kernel includes a plurality of downscaled kernel weights and is associated with an application; generate, based on the downscaled kernel and the kernel parameters, a kernel associated with the first resolution, wherein the kernel includes a plurality of weights and is associated with the application; and generate an output image based on the kernel and the image.

In some aspects, a method for image processing is provided. The method includes: obtaining a downscaled image of a scene, wherein the downscaled image is generated based on downscaling an image having a first resolution, the downscaled image including a second resolution that is lower than the first resolution; generating, using a kernel prediction network based on the downscaled image, kernel parameters and a downscaled kernel associated with the second resolution, wherein the downscaled kernel includes a plurality of downscaled kernel weights and is associated with an application; generating, based on the downscaled kernel and the kernel parameters, a kernel associated with the first resolution, wherein the kernel includes a plurality of weights and is associated with the application; and generating an output image based on the kernel and the image.

In some aspects, a non-transitory computer-readable medium is provided having stored thereon instructions that, when executed by at least one processor, cause the at least one processor to: obtain a downscaled image of a scene, wherein the downscaled image is generated based on downscaling an image having a first resolution, the downscaled image including a second resolution that is lower than the first resolution; generate, using a kernel prediction network based on the downscaled image, kernel parameters and a downscaled kernel associated with the second resolution, wherein the downscaled kernel includes a plurality of downscaled kernel weights and is associated with an application; generate, based on the downscaled kernel and the kernel parameters, a kernel associated with the first resolution, wherein the kernel includes a plurality of weights and is associated with the application; and generate an output image based on the kernel and the image.

In some aspects, an apparatus for image processing is provided. The apparatus includes: means for a downscaled image of a scene, wherein the downscaled image is generated based on downscaling an image having a first resolution, the downscaled image including a second resolution that is lower than the first resolution; means for generating, using a kernel prediction network based on the downscaled image, kernel parameters and a downscaled kernel associated with the second resolution, wherein the downscaled kernel includes a plurality of downscaled kernel weights and is associated with an application; means for generating, based on the downscaled kernel and the kernel parameters, a kernel associated with the first resolution, wherein the kernel includes a plurality of weights and is associated with the application; and means for generating an output image based on the kernel and the image.

Some aspects include a device having a processor (or multiple processors) configured to perform one or more operations of any of the methods summarized above. In some cases, the processor(s) can include a neural processing unit (NPU), a neural signal processor (NSP), a digital signal processor (DSP), a graphics processing unit (GPU), a central processing unit (CPU), any combination thereof, and/or other processor(s). Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

In some aspects, one or more of the apparatuses described herein is, is part of, and/or includes an extended reality (XR) device or system (e.g., a virtual reality (VR) device, an augmented reality (AR) device, or a mixed reality (MR) device), a mobile device (e.g., a mobile telephone or other mobile device), a wearable device, a wireless communication device, a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an architecture of an image capture and processing system, in accordance with some aspects of the disclosure.

FIG. 2 is a block diagram illustrating an example of a deep learning network, in accordance with some aspects of the disclosure.

FIG. 3 is a block diagram illustrating an example of a convolutional neural network, in accordance with some aspects of the disclosure.

FIG. 4 is a diagram illustrating an example of a convolutional operation using a kernel to modify an image, in accordance with some aspects of the disclosure.

FIG. 5 is a diagram illustrating an example of a process for image processing using a context aware spatially varying kernel, in accordance with some aspects of the disclosure.

FIG. 6 is a diagram illustrating an example of a process for upscaling a downscaled kernel to produce a kernel with a full resolution, in accordance with some aspects of the disclosure.

FIG. 7 is a diagram illustrating an example of an architecture for image processing using a context aware, spatially varying kernel weights, in accordance with some aspects of the disclosure.

FIG. 8 is a diagram illustrating an example of an existing process for denoising from a previous image frame, in accordance with some aspects of the disclosure.

FIG. 9 is a diagram illustrating an example of a process for denoising from a previous image frame, in accordance with some aspects of the disclosure.

FIG. 10 is a diagram illustrating an example of a process for high dynamic range (HDR) fusion, in accordance with some aspects of the disclosure.

FIG. 11 is a diagram illustrating an example of a process for multi-frame noise reduction (MFNR), in accordance with some aspects of the disclosure.

FIG. 12 is a diagram illustrating an example of a process for a multi-head kernel prediction network (KPN) that predicts task specific kernels, in accordance with some aspects of the disclosure.

FIG. 13 is a flow diagram illustrating an example of a process for image processing using a context aware spatially varying kernel, in accordance with some aspects of the disclosure.

FIG. 14 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

A camera is a device that receives light and captures image frames, such as still images or video frames, using an image sensor. The terms “image,” “image frame,” and “frame” are used interchangeably herein. Cameras may include processors, such as image signal processors (ISPs), that can receive one or more image frames and process the one or more image frames. For example, a raw image frame captured by a camera sensor can be processed by an ISP to generate a final image. Processing by the ISP can be performed by a plurality of filters or processing blocks being applied to the captured image frame, such as denoising or noise filtering, edge enhancement, color balancing, contrast, intensity adjustment (such as darkening or lightening), tone adjustment, among others. Image processing blocks or modules may include lens/sensor noise correction, Bayer filters, de-mosaicing, color conversion, correction or enhancement/suppression of image attributes, denoising filters, sharpening filters, among others.

Cameras can be configured with a variety of image capture and image processing operations and settings. The different settings result in images with different appearances. Some camera operations are determined and applied before or during capture of the image, such as automatic exposure control (AEC) and automatic white balance (AWB) processing. Additional camera operations applied before, during, or after capture of an image include operations involving zoom (e.g., zooming in or out), ISO, aperture size, f/stop, shutter speed, and gain. Other camera operations can configure post-processing of an image, such as alterations to contrast, brightness, saturation, sharpness, levels, curves, or colors.

As previously mentioned, recently, there has been an increase in popularity of modifying (e.g., denoising, sharpening, deblurring, re-mosaicing, and de-mosaicing) and introducing effects (e.g., blurring effects, such as bokeh) into images or into video including a plurality of images. Rendering of modifications and effects in images can be costly in terms of power consumption.

Modifying and introducing effects into images can be achieved by utilizing a neural network including a plurality of convolutional layers. A convolutional layer is a layer of neural nodes in neural network that can include convolutional filters (also referred to as kernels) that can be convolved with a full set of input features (e.g., pixels) of an input image to generate or extract a set of features (e.g., a feature pattern). For instance, the convolutional filter (or kernel) includes parameters which are convolved with the input features to extract the feature pattern. In one illustrative example, the convolutional filter (or kernel) can be convolved with features in local neighboring areas sequentially throughout the entire input feature set of the input image to generate desired outputs. A convolutional layer can promote a given feature pattern in the sample by enhancing feature structures similar to the feature pattern and hiding other feature patterns. A convolutional layer can be considered to be a filter because it filters the input features of the input image to enhance the given feature pattern. The feature pattern can include a small number of neighboring features.

Currently, existing configurable logic cells (CLCs) associated with image processing tasks (e.g., active noise reduction (ANR), high ISO noise reduction (HNR), auto scene finder (ASF), and MFNR (multi-frame noise reduction)) have a fixed set of kernel weights, and use region-based heuristics for the kernel application. These CLCs reside within the hardware of mobile device (e.g., smartphone) architectures. The CLCs are blocks that receive as an input an image, and process the image by performing a convolutional operation with a kernel with fixed kernel weights to produce an output image. The fixed kernel weights typically rely on some user-based heuristics to be applied to certain regions of the image. This user-driven approach requires heuristics that are pre-decided or pre-computed.

Therefore, improved systems and techniques for modifying and introducing effects into images without requiring user-based heuristics, while reducing the amount of required power, can be beneficial.

In one or more aspects of the present disclosure, systems, apparatuses, methods (also referred to as processes), and computer-readable media (collectively referred to herein as “systems and techniques”) are described herein that provide solutions for image processing using a context aware spatially varying kernel.

Various aspects relate generally to image processing. Some aspects more specifically relate to systems and techniques that provide solutions that employ a kernel prediction network (KPN) to deduce context aware, spatially varying, kernel weights across an image. In one or more examples, the systems and techniques provide a hybrid scheme, which can include a processor, such as a neural signal processor (NSP), and can include hardware, which may include an image signal processor (ISP). The KPN can operate on the processor (e.g., NSP) to perform kernel parameter prediction, and the ISP of the hardware can perform the kernel application (e.g., convolution operation) to generate the final processed image. More specifically, a downscaled image can be provided to the KPN in the NSP to generate predicted kernel weights, and the predicted kernel weights can then be used in the ISP for an application at full resolution.

In one or more examples, the systems and techniques provide a machine learning based solution that taken an image in a downscaled resolution as an input, and predicts a kernel parameter map at that same downscaled resolution. Running with a downscaled resolution can ensure a lower power consumption (e.g., for the hardware to the NSP to the hardware bandwidth transfer), a lower number of multiply-accumulate (MAC) operations (e.g., which can result in a reduced latency and reduced NSP power consumption), predicted weights are used by the ISP for the kernel application in the hardware, per pixel kernel deduction at full resolution happens via learned parameters, and deduced kernel values are used for convolution to obtain the final output.

In one or more aspects, during operation of a method for image processing, a first processor (e.g., a neural signal processor (NSP)) can obtain a downscaled image of a scene. The downscaled image can be generated based on downscaling an image having a first resolution. The downscaled image can include a second resolution that is lower than the first resolution. In one or more examples, a second processor (e.g., image signal processor (ISP)) can downscale the image to generate the downscaled image. The first processor using a kernel prediction network (KPN), can generate, based on context of the scene of the downscaled image, kernel parameters and a downscaled kernel associated with the second resolution. The downscaled kernel can include a plurality of downscaled kernel weights and can be associated with an application. The second processor can generate, based on the downscaled kernel and the kernel parameters, a kernel associated with the first resolution. The kernel can include a plurality of weights and can be associated with the application. The second processor can generate, based on applying the kernel to the image for the application, an output image.

In one or more examples, the kernel parameters can include a first parameter (p1) associated with an order (O) of a size of the kernel and a second parameter (p2) that depends on a ratio of the first resolution to the second resolution (corresponding to an upscale factor from the second resolution to the first resolution). The kernel can be generated using various techniques. For instance, the kernel can be generated by utilizing the second parameter in various ways to obtain a kernel map associated with the first resolution. The first parameter can be used to obtain the kernel filter coefficients for each pixel at the first resolution. In one illustrative example, the kernel can be generated further based on convolving the downscaled kernel with the second parameter to produce a kernel map associated with the first resolution, and based on convolving the kernel map with the first parameter.

In some examples, the first processor can obtain an additional downscaled image including the second resolution. The additional downscaled image can be generated based on downscaling an additional image having the first resolution. The kernel prediction network can generate, based on the context of the scene of the additional downscaled image, additional kernel parameters and an additional downscaled kernel associated with the second resolution. The additional downscaled kernel can be associated with the application. The second processor can generate, based on the additional downscaled kernel and the additional kernel parameters, an additional kernel associated with the first resolution. The additional kernel can include a plurality of additional weights and can be associated with the application. In one or more examples, the application can be a denoising application. In some examples, the kernel prediction network can be a machine learning (ML) model, and the kernel prediction network can generate the downscaled kernel and the additional downscaled kernel during a same forward pass of the machine learning model. In one or more examples, the second processor can generate, based on combining the kernel and the additional kernel, a final kernel. In one or more examples, the image can be captured with a first exposure time and the additional image can be captured with a second exposure time different from the first exposure time. In some examples, the image can include a first amount of noise and the additional image can include a second amount of noise different from the first amount of noise.

In one or more examples, the kernel prediction network can generate, based on the context of the scene of the downscaled image, additional kernel parameters and an additional downscaled kernel associated with the second resolution. The additional downscaled kernel can be associated with an additional application that is different than the application. The second processor can generate, based on the additional downscaled kernel and the additional kernel parameters, an additional kernel associated with the first resolution. The additional kernel can include a plurality of additional weights and can be associated with the additional application. The second processor can generate, based on applying the additional kernel to the image for the additional application, an additional output image.

In some examples, the plurality of weights of the kernel can be spatially varied across the image. In one or more examples, the application can be denoising, sharpening, deblurring, blurring, re-mosaicing, or de-mosaicing. In some examples, the first processor can be a neural signal processor (NSP), neural processing unit (NPU), or a digital signal processor (DSP). In one or more examples, the second processor can be an image signal processor (ISP). In some examples, the kernel prediction network can be a machine learning network. In some examples, a device (e.g., a mobile device, such as a smartphone) can include the first processor and the second processor.

Particular aspects of the subject matter described in this disclosure can be implemented to realize one or more of the following potential advantages. In one or more examples, the systems and techniques can provide a benefit of providing flexibility in terms of extending to multiple different image processing tasks, such as denoising (e.g., which may be performed in the image processing engine (IPE)/image front end (IFE)), sharpening (e.g., which may be performed in the IPE), deblurring (e.g., which may be performed in the IPE), blurring (e.g., which may be performed in the IPE), re-mosaicing (e.g., which may be performed in the top front end (TFE)), de-mosaicing (e.g., which may be performed in the TFE). In some examples, the systems and techniques can provide a benefit of providing flexibility in terms of extending to multi-frame image processing tasks (e.g., multi-frame noise reduction (MFNR)/multi-criteria token fusion (MCTF)/high dynamic range (HDR) fusion, Video MCTF, and Snapshot MFNR). In one or more examples, the systems and techniques can provide a benefit of providing flexibility in terms of harnessing spatial correlation between multiple frames, where a KPN model call can occur once for every N number of frames (e.g., which can be power efficient, and can be used for applications, such as video denoising). In some examples, the systems and techniques can provide a benefit of allowing for different kernel sizes for different tasks (e.g., tasks like denoising may require larger kernel sizes for certain lighting conditions). In one or more examples, the systems and techniques can provide a benefit of allowing for a multi-head KPN, where a single model can predict kernel parameters for multiple tasks, such as denoising and sharpening. In some examples, the systems and techniques can provide a benefit of incorporating an existing CLC tunability for kernel prediction (e.g., to tune the denoise strength and/or to tune the sharpening strength).

Additional aspects of the present disclosure are described in more detail below. Various aspects of the systems and techniques described herein will be discussed below with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

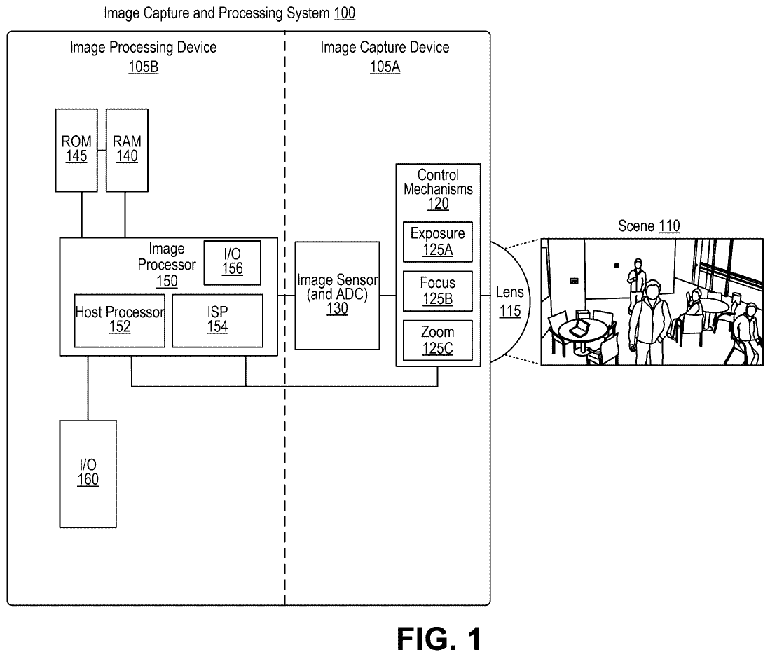

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. In some cases, the lens 115 and image sensor 130 can be associated with an optical axis. In one illustrative example, the photosensitive area of the image sensor 130 (e.g., the photodiodes) and the lens 115 can both be centered on the optical axis. A lens 115 of the image capture and processing system 100 faces a scene 110 and receives light from the scene 110. The lens 115 bends incoming light from the scene toward the image sensor 130. The light received by the lens 115 passes through an aperture. In some cases, the aperture (e.g., the aperture size) is controlled by one or more control mechanisms 120 and is received by an image sensor 130. In some cases, the aperture can have a fixed size.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, image processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

Returning to FIG. 1, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

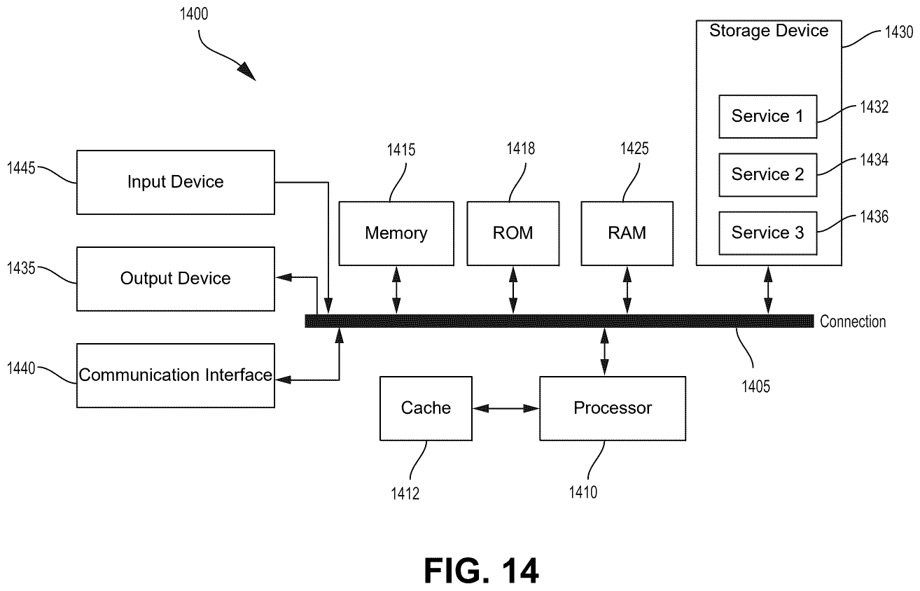

The image processor 150 may include one or more processors, such as one or more image signal processors (ISPs) (including ISP 154), one or more host processors (including host processor 152), and/or one or more of any other type of processor 1410 discussed with respect to the computing system 1400 of FIG. 14. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., BluetoothTM, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1425, read-only memory (ROM) 145/1420, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1435, any other input devices 1445, or some combination thereof. In some cases, a caption may be input into the image processing device 105B through a physical keyboard or keypad of the I/O devices 160, or through a virtual keyboard or keypad of a touchscreen of the I/O devices 160. The I/O devices 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O devices 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

Machine learning (ML) can be considered a subset of artificial intelligence (AI). ML systems can include algorithms and statistical models that computer systems can use to perform various tasks by relying on patterns and inference, without the use of explicit instructions. An example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is an example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

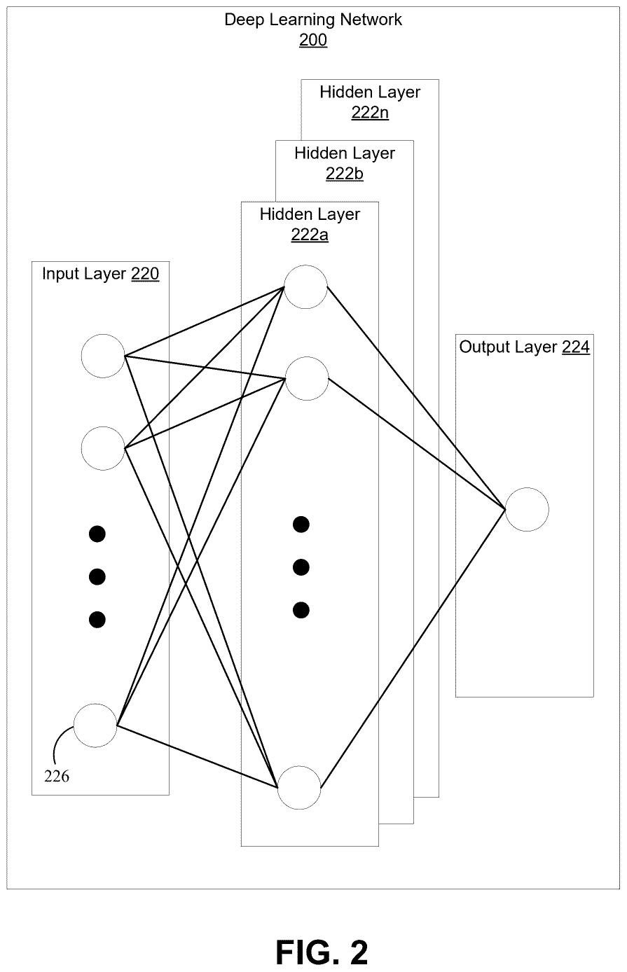

FIG. 2 is an illustrative example of a deep learning neural network 200 that can be used by the machine learning model. An input layer 220 includes input data. In some examples, the input layer 220 can include data representing the pixels of an input video frame. The neural network 200 includes multiple hidden layers 222a, 222b, through 222n. The hidden layers 222a, 222b, through 222n include “n” number of hidden layers, where “n” is an integer greater than or equal to one. The number of hidden layers can be made to include as many layers as needed for the given application. The neural network 200 further includes an output layer 224 that provides an output resulting from the processing performed by the hidden layers 222a, 222b, through 222n. In some examples, the output layer 224 can provide a classification for an object in an input video frame. The classification can include a class identifying the type of object (e.g., a person, a dog, a cat, or other object).

The neural network 200 is a multi-layer neural network of interconnected nodes. Each node can represent a piece of information. Information associated with the nodes is shared among the different layers and each layer retains information as information is processed. In some cases, the neural network 200 can include a feed-forward network, in which case there are no feedback connections where outputs of the network are fed back into itself. In some cases, the neural network 200 can include a recurrent neural network, which can have loops that allow information to be carried across nodes while reading in input.

Information can be exchanged between nodes through node-to-node interconnections between the various layers. Nodes of the input layer 220 can activate a set of nodes in the first hidden layer 222a. For example, as shown, each of the input nodes of the input layer 220 is connected to each of the nodes of the first hidden layer 222a. The nodes of the hidden layers 222a, 222b, through 222n can transform the information of each input node by applying activation functions to the information. The information derived from the transformation can then be passed to and can activate the nodes of the next hidden layer 222b, which can perform their own designated functions. Example functions include convolutional, up-sampling, data transformation, and/or any other suitable functions. The output of the hidden layer 222b can then activate nodes of the next hidden layer, and so on. The output of the last hidden layer 222n can activate one or more nodes of the output layer 224, at which an output is provided. In some cases, while nodes (e.g., node 226) in the neural network 200 are shown as having multiple output lines, a node has a single output and all lines shown as being output from a node represent the same output value.

In some cases, each node or interconnection between nodes can have a weight that is a set of parameters derived from the training of the neural network 200. Once the neural network 200 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 200 to be adaptive to inputs and able to learn as more and more data is processed.

The neural network 200 is pre-trained to process the features from the data in the input layer 220 using the different hidden layers 222a, 222b, through 222n in order to provide the output through the output layer 224. In an example in which the neural network 200 is used to identify objects in images, the neural network 200 can be trained using training data that includes both images and labels. For instance, training images can be input into the network, with each training image having a label indicating the classes of the one or more objects in each image (basically, indicating to the network what the objects are and what features they have). In some examples, a training image can include an image of a number 2, in which case the label for the image can be [0 0 1 0 0 0 0 0 0 0].

In some cases, the neural network 200 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 200 is trained well enough so that the weights of the layers are accurately tuned.

For the example of identifying objects in images, the forward pass can include passing a training image through the neural network 200. The weights are initially randomized before the neural network 200 is trained. The image can include, for example, an array of numbers representing the pixels of the image. Each number in the array can include a value from 0 to 255 describing the pixel intensity at that position in the array. In some examples, the array can include a 28×28×3 array of numbers with 28 rows and 28 columns of pixels and 3 color components (such as red, green, and blue, or luma and two chroma components, or the like).

For a first training iteration for the neural network 200, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 200 is unable to determine low level features and thus cannot make an accurate determination of what the classification of the object might be. A loss function can be used to analyze error in the output. Any suitable loss function definition can be used. An example of a loss function includes a mean squared error (MSE). The MSE is defined as

$${E}_{total} = \sum \frac{1}{2} {( target - output )}^{2} ,$$

which calculates the sum of one-half times a ground truth output (e.g., the actual answer) minus the predicted output (e.g., the predicted answer) squared. The loss can be set to be equal to the value of Etotal.

The loss (or error) will be high for the first training images since the actual values will be much different than the predicted output. The goal of training is to minimize the amount of loss so that the predicted output is the same as the training label. The neural network 200 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{d W} ,$$

where w denotes a weight, wᵢ denotes the initial weight, and η denotes a learning rate. The learning rate can be set to any suitable value, with a high learning rate including larger weight updates and a lower value indicating smaller weight updates.

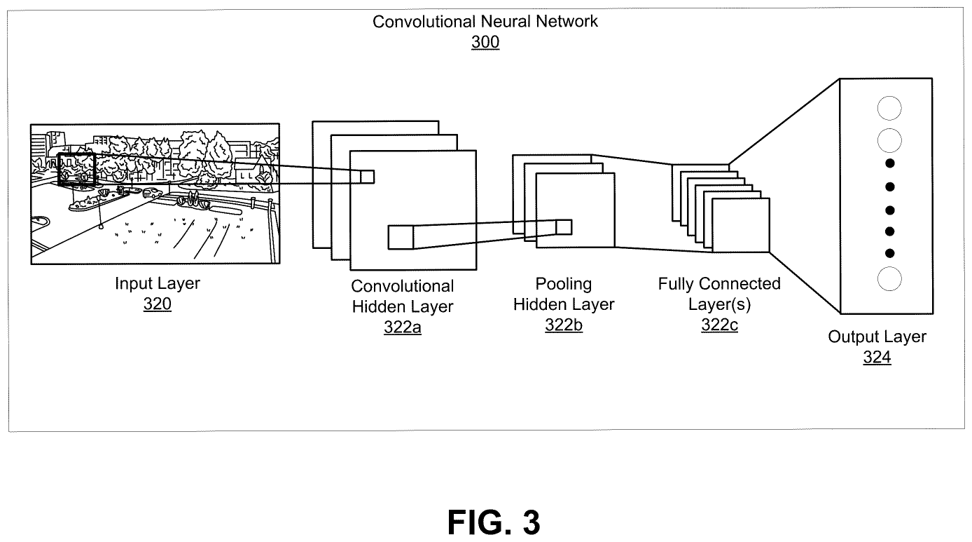

The neural network 200 can include any suitable deep network. As described previously, an example of a neural network 200 includes a convolutional neural network (CNN), which includes an input layer and an output layer, with multiple hidden layers between the input and out layers. An example of a CNN is described below with respect to FIG. 3. The hidden layers of a CNN include a series of convolutional, nonlinear, pooling (for downsampling), and fully connected layers. The neural network 200 can include any other deep network other than a CNN, such as an autoencoder, a deep belief nets (DBNs), a Recurrent Neural Networks (RNNs), among others.

FIG. 3 is an illustrative example of a convolutional neural network 300 (CNN 300). The input layer 320 of the CNN 300 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 322a, an optional non-linear activation layer, a pooling hidden layer 322b, and fully connected hidden layers 322c to get an output at the output layer 324. While only one of each hidden layer is shown in FIG. 3, one of ordinary skill will appreciate that multiple convolutional hidden layers, non-linear layers, pooling hidden layers, and/or fully connected layers can be included in the CNN 300. As previously described, the output can indicate a single class of an object or can include a probability of classes that best describe the object in the image.

The first layer of the CNN 300 is the convolutional hidden layer 322a. The convolutional hidden layer 322a analyzes the image data of the input layer 320. Each node of the convolutional hidden layer 322a is connected to a region of nodes (pixels) of the input image called a receptive field. The convolutional hidden layer 322a can be considered as one or more filters (each filter corresponding to a different activation or feature map), with each convolutional iteration of a filter being a node or neuron of the convolutional hidden layer 322a. For example, the region of the input image that a filter covers at each convolutional iteration would be the receptive field for the filter. In some examples, if the input image includes a 28×28 array, and each filter (and corresponding receptive field) is a 5×5 array, then there will be 24×24 nodes in the convolutional hidden layer 322a. Each connection between a node and a receptive field for that node learns a weight and, in some cases, an overall bias such that each node learns to analyze its particular local receptive field in the input image. Each node of the hidden layer 322a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 322a is due to each node of the convolutional layer being applied to its corresponding receptive field. For example, a filter of the convolutional hidden layer 322a can begin in the top-left corner of the input image array and can convolve around the input image. As noted above, each convolutional iteration of the filter can be considered a node or neuron of the convolutional hidden layer 322a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 322a.

For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 322a.

The mapping from the input layer to the convolutional hidden layer 322a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 322a can include several activation maps in order to identify multiple features in an image. The example shown in FIG. 3 includes three activation maps. Using three activation maps, the convolutional hidden layer 322a can detect three different kinds of features, with each feature being detectable across the entire image.

In some examples, a non-linear hidden layer can be applied after the convolutional hidden layer 322a. The non-linear layer can be used to introduce non-linearity to a system that has been computing linear operations. One illustrative example of a non-linear layer is a rectified linear unit (ReLU) layer. A ReLU layer can apply the function f(x)=max(0,x) to all of the values in the input volume, which changes all the negative activations to 0. The ReLU can thus increase the non-linear properties of the CNN 300 without affecting the receptive fields of the convolutional hidden layer 322a.

The pooling hidden layer 322b can be applied after the convolutional hidden layer 322a (and after the non-linear hidden layer when used). The pooling hidden layer 322b is used to simplify the information in the output from the convolutional hidden layer 322a. For example, the pooling hidden layer 322b can take each activation map output from the convolutional hidden layer 322a and generates a condensed activation map (or feature map) using a pooling function. Max-pooling is an example of a function performed by a pooling hidden layer. Other forms of pooling functions be used by the pooling hidden layer 322a, such as average pooling, L2-norm pooling, or other suitable pooling functions. A pooling function (e.g., a max-pooling filter, an L2-norm filter, or other suitable pooling filter) is applied to each activation map included in the convolutional hidden layer 322a. In the example shown in FIG. 3, three pooling filters are used for the three activation maps in the convolutional hidden layer 322a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 322a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 322a having a dimension of 24×24 nodes, the output from the pooling hidden layer 322b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 300.

The final layer of connections in the network is a fully-connected layer that connects every node from the pooling hidden layer 322b to every one of the output nodes in the output layer 324. Using the example above, the input layer includes 28×28 nodes encoding the pixel intensities of the input image, the convolutional hidden layer 322a includes 3×24×24 hidden feature nodes based on application of a 5×5 local receptive field (for the filters) to three activation maps, and the pooling layer 322b includes a layer of 3×12×12 hidden feature nodes based on application of max-pooling filter to 2×2 regions across each of the three feature maps. Extending this example, the output layer 324 can include ten output nodes. In such an example, every node of the 3×12×12 pooling hidden layer 322b is connected to every node of the output layer 324.

The fully connected layer 322c can obtain the output of the previous pooling layer 322b (which should represent the activation maps of high-level features) and determines the features that most correlate to a particular class. For example, the fully connected layer 322c layer can determine the high-level features that most strongly correlate to a particular class, and can include weights (nodes) for the high-level features. A product can be computed between the weights of the fully connected layer 322c and the pooling hidden layer 322b to obtain probabilities for the different classes. For example, if the CNN 300 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 324 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In some examples, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

As previously mentioned, recently, there has been an increase in popularity of modifying (e.g., denoising, sharpening, deblurring, re-mosaicing, and de-mosaicing) and introducing effects (e.g., blurring effects, such as bokeh) into images or into video including a plurality of images. The modifications and effects can be introduced into an image by convolving the image with a kernel that corresponds to a feature pattern.

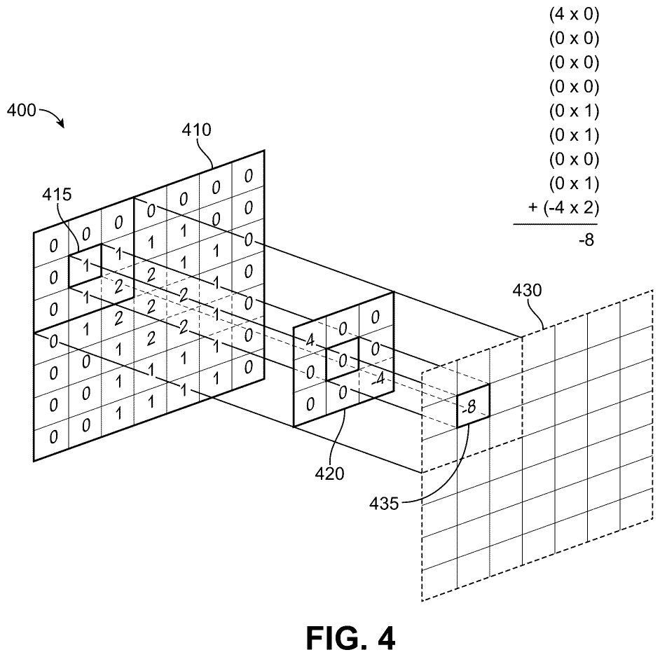

FIG. 4 shows an example of a convolutional operation using a kernel to modify an image. In particular, FIG. 4 is a diagram illustrating an example 400 of a convolutional operation using a kernel 420 to render bokeh (e.g., blur) in an image.

Convolution is an operation performed on two functions (e.g., f and g) to produce a third function. Convolution can operate in one dimension (1D) (e.g., for speech processing), in two dimensions (2D) (e.g., for image processing), or in three dimensions (3D) (e.g., for video processing). In image processing, convolution is the process of transforming an image (e.g., a source image, such as image 410) by applying a kernel (e.g., kernel 420) over each pixel and the pixel's local neighboring pixels across the entire image (e.g., image 410). The kernel (e.g., kernel 420) is a matrix of values whose size and values determine the transformation effect of the convolution process.

During operation of the convolution process, the kernel 420 is placed over each pixel (e.g., pixel 415) of the image 410, while ensuring that the full kernel 420 (e.g., the kernel matrix) is contained within the image 410. As the kernel 420 is placed over each pixel (e.g., pixel 415) in the image 410, each value of the kernel 420 can be multiplied with the corresponding pixel (e.g., pixel 415) in the image 410 that the kernel 420 is placed over. The resulting multiplied values can be summed together to produce a resulting value, which will become the new value of the center pixel (e.g., pixel 435 of a resultant image 430). This convolution process can be repeated across all of the pixels within the entire image 410.

For example, as shown in FIG. 4, a three by three (3×3) kernel (e.g., the kernel 420) is convolved with a seven by seven (7×7) matrix source image (e.g., the image 410). The center element of the kernel 420 is placed over the source pixel (e.g., pixel 415) of the image 410. The source pixel (e.g., pixel 415) can be replaced with a weighted sum of itself and surrounding pixels. The output is placed in the destination pixel value (e.g., pixel 435 of the resultant image 430).

In this example, at the first position, a “0” is in the source pixel of the image 410 and a “4” is in the kernel 420 (e.g., where 4×0 is 0). Moving to the next pixel in the image 410, a “0” is in the source pixel of the image 410 and a “0” is in the kernel (e.g., where 0×0 is 0). The process repeats for the remaining pixels in the image 410 covered by the kernel 420. Summing up all of these results gives “−8”. As such, the output of this convolution operation will be “−8”. This result can then be updated in the corresponding pixel 435 in the resultant image 430.

The output of the convolution process changes with the changing values of the kernel 420. Similar to how the values of the kernel 420 can be varied for different levels of effects, the size of the kernel 420 can also be modified to shape the effect of the convolution. By increasing the size of the kernel matrix (e.g., of the kernel 420), the spatial locality influencing each pixel's resulting value is increased as pixels from further away are being pulled into the equation.

Convolution is the key concept in CNNs. As previously mentioned, CNNs are a type of deep neural network. As shown in FIG. 3, a CNN can include a convolutional layer (e.g., convolutional hidden layer 322a), a pooling layer (e.g., pooling hidden layer 322b), and a fully-connected layer (e.g., fully-connected layer(s) 322c). At the convolutional layer, a CNN applies a convolution onto its inputs using a kernel matrix that it calibrates through training. For this reason, CNNs are good at feature matching in images and object classification. The convolutional layer parameters include a set of learnable kernels. Every kernel is small matrix that extends through the full depth of the input volume. During the forward pass, each kernel is convolved across the width and height of the input image, and dot products can be computed between the pixel values of the source image and the kernel at corresponding positions.

As mentioned, currently, existing CLCs associated with image processing tasks (e.g., ANR, HNR, ASF, and MFNR) have a fixed set of kernel weights, and use region-based heuristics for the kernel application. These CLCs are located within the hardware of mobile device (e.g., smartphone) architectures. The CLCs receive an image as an input, and process the image by performing a convolutional operation with a kernel with fixed kernel weights to produce an output image. The fixed kernel weights usually rely on user-based heuristics to be applied to certain regions of the image and, thus, this user-driven approach requires heuristics that are pre-decided or pre-computed. As such, improved systems and techniques for modifying and introducing effects into images without requiring user-based heuristics, while reducing the amount of required power, can be useful.

In one or more aspects, the systems and techniques provide solutions for image processing using a context aware spatially varying kernel. In one or more examples, the solutions include a kernel prediction network (KPN) to determine context aware, spatially varying, kernel weights across an image. More specifically, for the systems and techniques, a downscaled image can be provided to the KPN (e.g., located in an NSP) to produce predicted kernel weights, and the predicted kernel weights can be used (e.g., in an ISP) for application at full resolution.

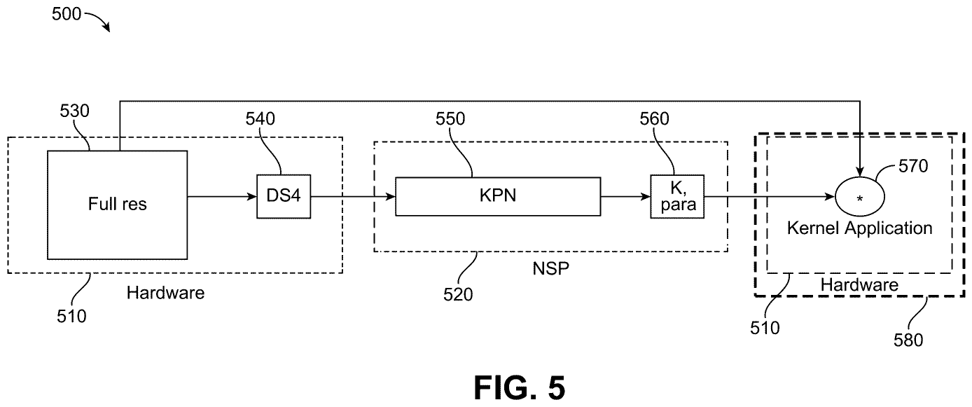

FIG. 5 shows an example process for image processing employing a KPN to determine context aware, spatially varying, kernel weights. In particular, FIG. 5 is a diagram illustrating an example of a process 500 for image processing using a context aware spatially varying kernel. In FIG. 5, a hybrid scheme is shown including a first processor 520 (e.g., an NSP) and hardware 510 (e.g., including a second processor, such as an ISP). In one or more examples, the first processor 520 can be an NSP, NPU, or a DSP. In some examples, the second processor of the hardware 510 can be an ISP. 16. In one or more examples, a device, such as a mobile device (e.g., a smartphone, an XR device, or a wearable device), can include the first processor 520 (e.g., NSP) and the hardware 510 (e.g., including the second processor, such as an ISP).

During operation of the process 500 of FIG. 5, the second processor of the hardware 510 can downscale (e.g., downscale by four (4)) an image 530 (e.g., a full resolution image, such as an H*W size) of a scene to generate a downscaled image 540 (e.g., downscaled to a DS4 resolution, such as a W/4*H/4 size). The downscaled image 540 can be generated based on downscaling the image 530 having a first resolution (e.g., the full resolution). The downscaled image 540 can have a second resolution (e.g., a DS4 resolution) that is lower than the first resolution (e.g., the full resolution). The hardware 510 can send the downscaled image 540 to the first processor 520.

The first processor 520 can obtain, from the hardware 510, the downscaled image 540 of the scene. After obtaining the downscaled image 540, the first processor 520 can generate, by using a KPN 550, based on context of the scene of the downscaled image 540, an output 560. The output 560 can include kernel parameters (para) (e.g., for the full resolution) and a downscaled kernel (K) associated with the second resolution (e.g., a DS4 resolution). In one or more examples, the KPN 550 can be a machine learning network. The downscaled kernel (K) can include a plurality of downscaled kernel weights, and can associated with an application (e.g., an image processing task). The first processor 520 can send the output 560 to the hardware 510. In one or more examples, the application (e.g., image processing task) can be denoising, sharpening, deblurring, blurring, re-mosaicing, or de-mosaicing.

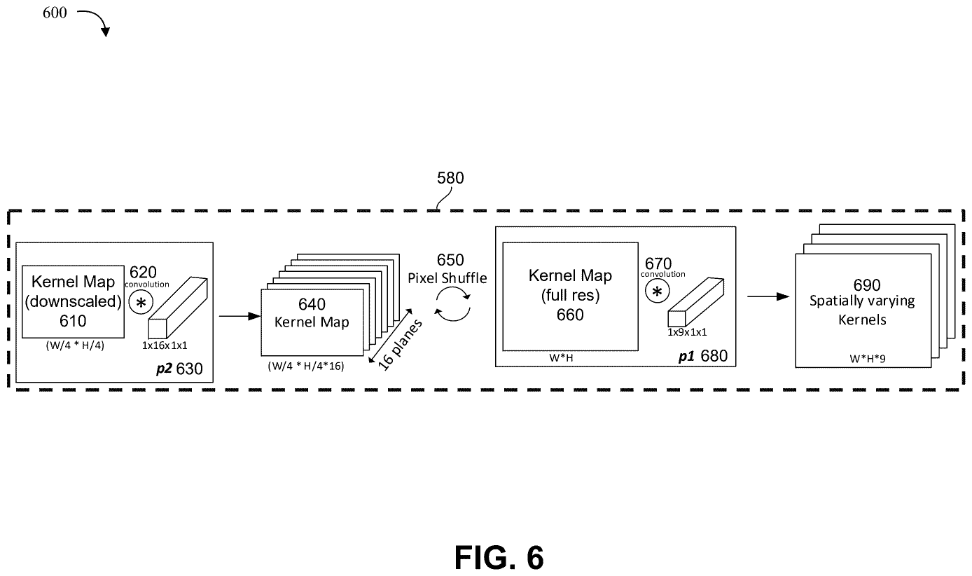

The hardware 510 can obtain the output 560 from the first processor 520. The second processor of the hardware 510 can generate, based on the downscaled kernel (K) and the kernel parameters (para), a kernel associated with the first resolution (e.g., the full resolution). The kernel can have a plurality of weights, and can be associated with the application. In one or more examples, the plurality of weights of the kernel can be spatially varied across the image 530. Details of the process 580 for upscaling the downscaled kernel (K) to produce the kernel with the full resolution are described in the description of FIG. 6.

The second processor of the hardware 510 can then generate, based on applying the kernel (e.g., with the full resolution) to the image 530 (e.g., with the full resolution) for the application, an output image. In some examples, applying the kernel to the image 530 for the application can involve convolving 570 the kernel (e.g., with the full resolution) with the image 530 (e.g., with the full resolution).

FIG. 6 shows an example process for upscaling the downscaled kernel (K) to produce the kernel with the full resolution. In particular, FIG. 6 is a diagram illustrating an example 600 of a process 580 for upscaling the downscaled kernel (K) to produce a kernel with a full resolution (e.g., the first resolution). In one or more examples, the kernel parameters (para) comprise a first parameter (p1) 680 associated with an order (O) of a size of the kernel, and a second parameter (p2) 630 that depends on a ratio of the first resolution to the second resolution (corresponding to an upscale factor from the second resolution to the first resolution). In some examples, the order (O) of the kernel can be for a per pixel kernel.

During operation of the process 580 of FIG. 6, the second processor of the hardware can utilize the second parameter p2 to generate or obtain a full resolution kernel map in multiple ways. For instance, to perform 4× upscaling (upscaling by a factor of 4), one way is to use a convolutional layer including a 1×1 kernel and 16 parameters of p2 as 16 channels followed by a pixel shuffle operation, another way is to use a convtranspose 2d layer of stride 4 and 36 parameters of p2 acting as 6×6 kernel size. In one illustrative example, the second processor of the hardware 510 can convolve 620 the downscaled kernel 610 (e.g., a downscaled kernel map with a DS4 resolution with a W/4*H/4 size) with the second parameter (p2) 630 (e.g., with 1×16×1×1 dimensions) to produce a downscaled kernel map 640 with 16 planes (e.g., W/4*H/4*16). In such an illustrative example, the second processor of the hardware 510 can perform a pixel shuffle 650 to produce a full resolution kernel map 660 (e.g., with a W*H size). As noted previously, the first parameter p1 depends on an order (O) of a size of the kernel (which can be referred to as O(Kernel size)), in which case, based on the kernel size O(Kernel size), the parameterization obtained from p1 can vary. Continuing with the illustrative example from above, the second processor of the hardware 510 can then convolve 670 the full resolution kernel map 660 (e.g., with a W*H size) with the first parameter (p1) 680 (e.g., with 1×9×1×1 dimensions) to produce spatially varying kernels 690 with 9 planes (e.g., W*H*9) with a full resolution.

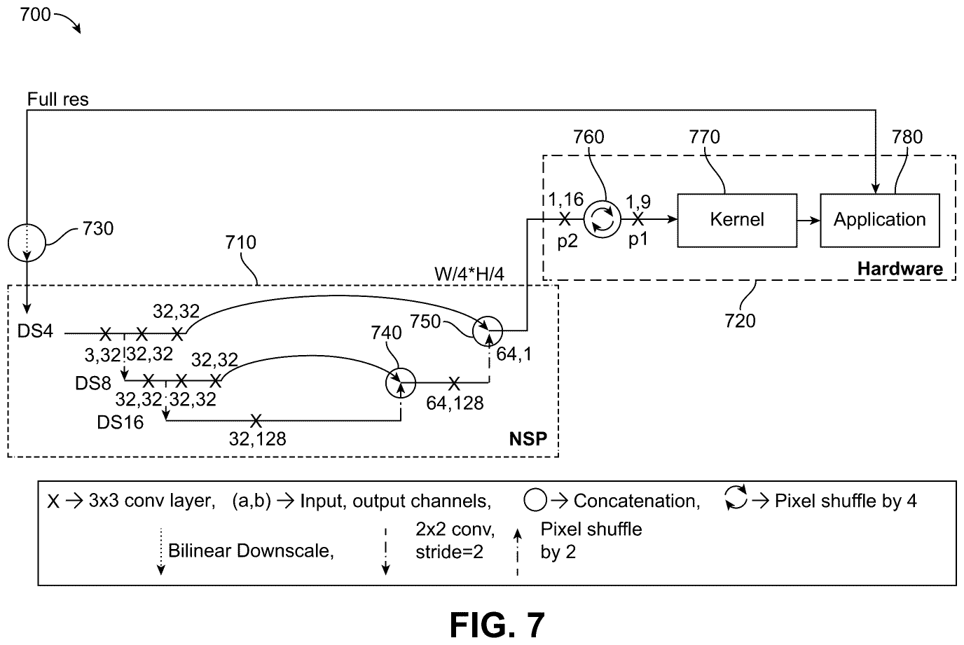

FIG. 7 shows an example architecture that may be employed for image processing using a context aware spatially varying kernel. In particular, FIG. 7 is a diagram illustrating an example of an architecture 700 for image processing using context aware, spatially varying kernel weights. The architecture 700 is inspired by the U-Net architecture (e.g., a convolutional neural network architecture), which leverages information across multiple scales. The architecture 700 is a similar architecture to the U-Net architecture, and is used to predict a kernel map.

In FIG. 7, the architecture 700 is shown to include a first processor 710 (e.g., an NSP) and hardware 720 (e.g., including a second processor, such as an ISP). The architecture 700 is also shown to include an encoder head 730, a decoder head 740, and a combiner 750.

During the training of the architecture 700 of FIG. 7, an image (e.g., raw data) with full resolution of a scene can be injected with noise to produce a noisy image. The noisy image can be downscaled (e.g., via bilinear interpolation) to produce a downscaled noisy image. For example, the noisy image with the full resolution can be passed through the encoder head 740 to the first processor 710 to be downscaled. The first processor 710 can downscale (e.g., via bilinear interpolation) the noisy image with the full resolution to DS4 resolution, a DS8 resolution, and a DS16 resolution. The first processor 710 can generate, based on the downscaled noisy image, a downscaled kernel (e.g., with a W/4*H/4 size) and parameters, including a first parameter p1 and a second parameter p2. The first processor 710 can send the downscaled kernel and the parameters to the hardware 720.

The hardware 720 can receive, from the first processor 710, the downscaled kernel and the parameters. The second processor of the hardware 720 can perform a pixel shuffle 760, based on the downscaled kernel and the parameters, to generate a full resolution kernel 770. In one or more examples, the downscaled kernel is upscaled and restructured (e.g., by the second processor) to generate the kernel 770. The kernel 770 is a spatially varying kernel (e.g., the kernel filter varies at each pixel). The second processor of the hardware 720 can then convolve the kernel 770 (e.g., for the application 780) with the full resolution noisy image to produce a denoised output. One or more processors can determine a loss between the denoised output can clean images of the scene (e.g., images without injected noise). In one or more examples, a combination of a multi-scale structural similarity (MS-SSIM) loss and/or a multi-scale Laplacian pyramid-based loss can be used for training, and an least absolute deviations (L1) loss can be used for validation.

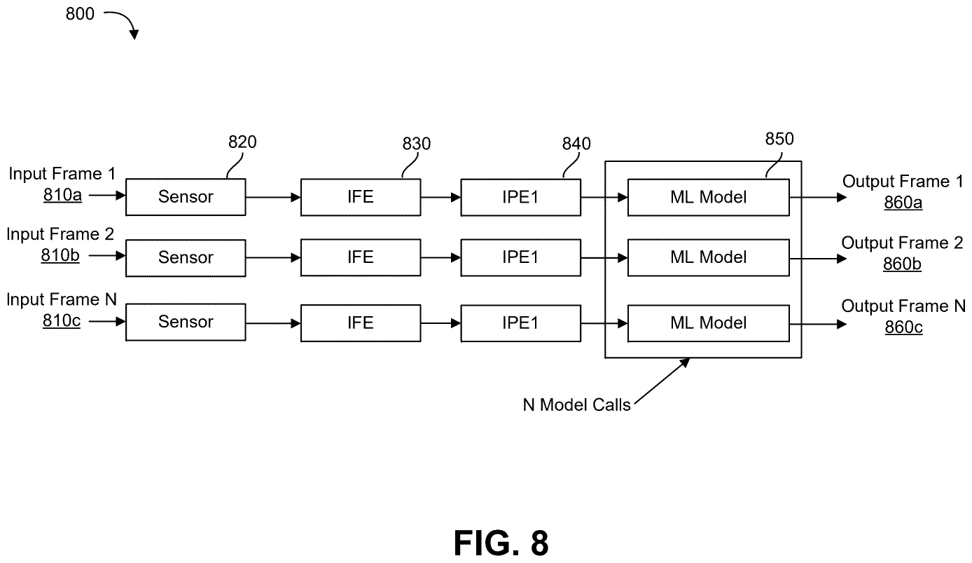

In one or more aspects, the systems and techniques for image processing using a context aware spatially varying kernel can be applied to a number of different use cases. FIGS. 8, 9, 10, 11, and 12 show examples of different use cases that the systems and techniques can be utilized.

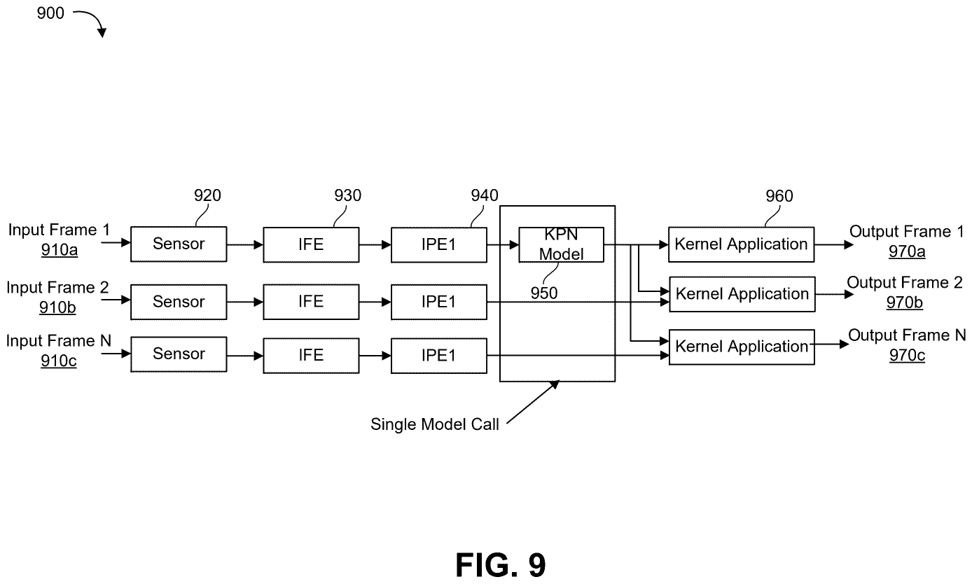

In one or more examples, FIGS. 8 and 9 show examples of processes (e.g., an ISP process flow) for a use case of denoising from a previous image frame. FIG. 8 shows an example existing process for denoising from a previous image frame, while FIG. 9 shows an example proposed process for denoising from a previous image frame.

In particular, FIG. 8 is a diagram illustrating an example of an existing process 800 for denoising from a previous image frame. In FIG. 8, during operation of the process 800, each sensor 820 of a plurality of sensors 820 can obtain a respective image (e.g., input frame 1 810a, input frame 2 810b, and input frame N 810c) of a scene at a full resolution. In one or more examples, each sensor 820 of the plurality of sensors 820 may obtain its respective image (e.g., input frame 1 810a, input frame 2 810b, and input frame N 810c) from a different camera pose and, as such, each of the respective images (e.g., input frame 1 810a, input frame 2 810b, and input frame N 810c) may have a different amount of noise from each other.

Each sensor 820 of the plurality of sensors 820 can send its respective image (e.g., input frame 1 810a, input frame 2 810b, and input frame N 810c) to a respective ML model 850 of a plurality of ML models 850 (e.g., via a respective IFE 830 of a plurality of IFEs 830 and via a respective IPE 1 840 of a plurality of IPE 1s 840). Each ML model 850 of the plurality of ML models 850 can perform a call (e.g., a model pass, such as a forward pass) on its respective image (e.g., input frame 1 810a, input frame 2 810b, input frame N 810c) to produce a respective output image (e.g., output frame 1 860a, output frame 2 860b, and output frame N 860c). As such, for the process 800, N number of model passes will occur.

FIG. 9 is a diagram illustrating an example of a proposed process 900 for denoising from a previous image frame. In FIG. 9, during operation of the process 900, each sensor 920 of a plurality of sensors 920 can obtain a respective image (e.g., input frame 1 910a, input frame 2 910b, and input frame N 910c) of a scene at a full resolution. In one or more examples, each sensor 920 of the plurality of sensors 920 can obtain its respective image (e.g., input frame 1 910a, input frame 2 910b, and input frame N 910c) from a different camera pose and, thus, each of the respective images (e.g., input frame 1 910a, input frame 2 910b, and input frame N 910c) can have a different amount of noise from each other.

Each sensor 920 of the plurality of sensors 920 can send its respective image (e.g., input frame 1 910a, input frame 2 910b, and input frame N 910c) to a single KPN model 950 (e.g., via a respective IFE 930 of a plurality of IFEs 930 and via a respective IPE 1 940 of a plurality of IPE 1 s 940). The KPN model 950 can perform a single call (e.g., a single model pass, such as the same forward pass) on the images (e.g., input frame 1 810a, input frame 2 810b, input frame N 810c) to produce a respective a kernel (e.g., with an application, such as a denoising application) associated with each of the images (e.g., input frame 1 910a, input frame 2 910b, and input frame N 910c). Each respective kernel can be applied to its associated image (e.g., input frame 1 810a, input frame 2 810b, input frame N 810c) for a respective kernel application 960 (e.g., the denoising application) to produce a respective output image (e.g., output frame 1 970a, output frame 2 970b, and output frame N 970c). As such, conversely to process 800, the process 900 only performs a single model pass and, as such, requires a lower power consumption.

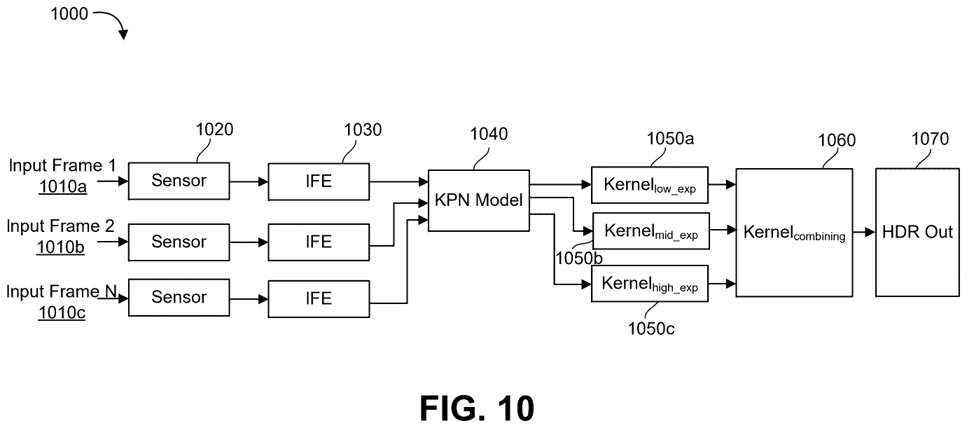

In one or more examples, FIG. 10 shows an example of a process (e.g., an ISP process flow) for a use case of high dynamic range (HDR) fusion. In particular, FIG. 10 is a diagram illustrating an example of a process 1000 for HDR fusion. In FIG. 10, during operation of the process 1000, each sensor 1020 of a plurality of sensors 1020 can obtain a respective image (e.g., input frame 1 1010a, input frame 2 1010b, and input frame N 1010c) of a scene at a full resolution. In one or more examples, each sensor 1020 of the plurality of sensors 1020 can obtain its respective image (e.g., input frame 1 1010a, input frame 2 1010b, and input frame N 1010c) using a different exposure time and, thus, each of the respective images (e.g., input frame 1 1010a, input frame 2 1010b, and input frame N 1010c) can have a different exposure time from each other. For example, the input frame 1 1010a can have a low exposure time, the input frame 2 1010b can have a middle exposure time, and the input frame N 1010c can have a high exposure time.

Each sensor 1020 of the plurality of sensors 1020 can send its respective image (e.g., input frame 1 1010a, input frame 2 1010b, and input frame N 1010c) to a single KPN model 1040 (e.g., via a respective IFE 1030 of a plurality of IFEs 1030). The KPN model 1040 can, based on the images (e.g., input frame 1 1010a, input frame 2 1010b, input frame N 1010c), produce a respective a kernel (e.g., kernel_{low_exposure} 1050a, kernel_{mid_exposure} 1050b, and kernel_{high_exposure} 1050c). The kernels (e.g., kernel_{low_exposure} 1050a, kernel_{mid_exposure} 1050b, and kernel_{high_exposure} 1050c) can be combined to generate a combined kernel (e.g., kernel_{combining} 1060). The combined kernel (e.g., kernel_{combining} 1060) can then be applied to the images (e.g., input frame 1 1010a, input frame 2 1010b, input frame N 1010c) for the application (e.g., the HDR fusion application) to produce an output image (e.g., HDR out 1070).

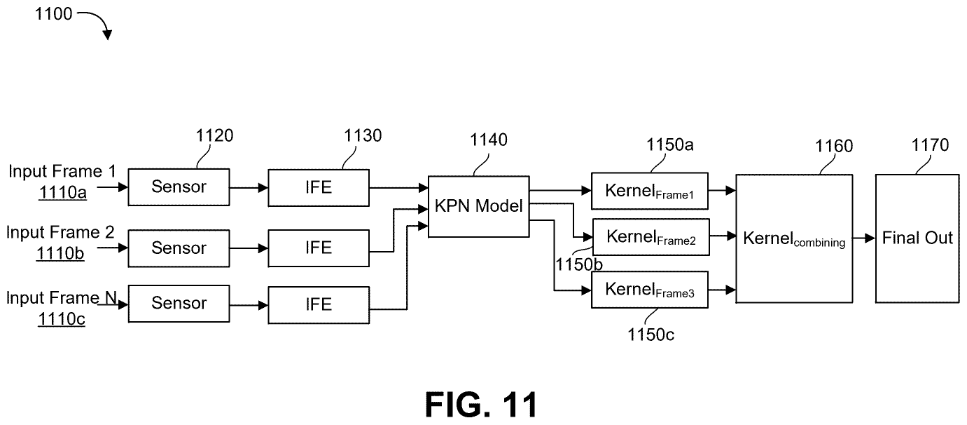

In one or more examples, FIG. 11 shows an example of a process (e.g., an ISP process flow) for a use case of multi-frame noise reduction (MFNR). In particular, FIG. 11 is a diagram illustrating an example of a process 1100 for MFNR. In FIG. 11, during operation of the process 1100, each sensor 1120 of a plurality of sensors 1120 can obtain a respective image (e.g., input frame 1 1110a, input frame 2 1110b, and input frame N 1110c) of a scene at a full resolution. In one or more examples, each sensor 1120 of the plurality of sensors 1120 can obtain its respective image (e.g., input frame 1 1110a, input frame 2 1110b, and input frame N 1110c) from a different camera pose and, thus, each of the respective images (e.g., input frame 1 1110a, input frame 2 1110b, and input frame N 1110c) can have a different amount of noise from each other.

Each sensor 1120 of the plurality of sensors 1120 can send its respective image (e.g., input frame 1 1110a, input frame 2 1110b, and input frame N 1110c) to a single KPN model 1140 (e.g., via a respective IFE 1130 of a plurality of IFEs 1130). The KPN model 1140 can, based on the images (e.g., input frame 1 1110a, input frame 2 1110b, input frame N 1110c), produce a respective a kernel (e.g., kernel_{frame1} 1150a, kernel_{frame2} 1150b, and kernel_{frame3} 1150c). The kernels (e.g., kernel_{frame1} 1150a, kernel_{frame2} 1150b, and kernel_{frame3} 1150c) can be combined to generate a combined kernel (e.g., kernel_{combining} 1160). The combined kernel (e.g., kernel_{combining} 1160) can then be applied to the images (e.g., input frame 1 1110a, input frame 2 1110b, input frame N 1110c) for the application (e.g., the MFNR application) to produce an output image (e.g., final out 1170).

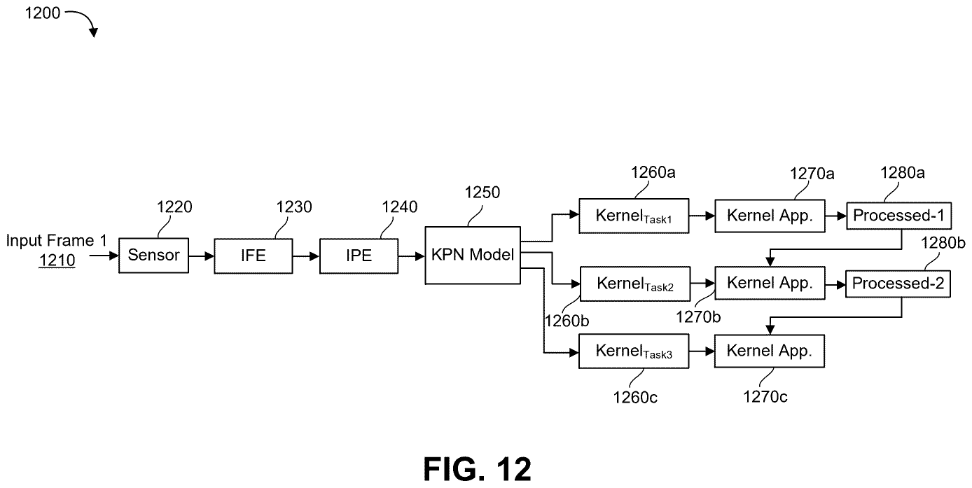

In one or more examples, FIG. 12 shows an example of a process (e.g., an ISP process flow) for a use case of multi-head KPN (e.g., for predicting task specific kernels). In particular, FIG. 12 is a diagram illustrating an example of a process 1200 for a multi-head kernel prediction network (KPN) that predicts task specific kernels. In FIG. 12, during operation of the process 1200, a sensor 1220 can obtain an image (e.g., input frame 1 1210) of a scene at a full resolution. The sensor 1220 can send the image 1210 to a KPN model 1250 (e.g., via an IFE 1230 and via an IPE 1 1240). The KPN model 1250 can, based on the image (e.g., input frame 1 1210), produce a plurality of kernels (e.g., kernelₜₐₛₖ₁ 1260a, kernelₜₐₛₖ₂ 1260b, and kernelₜₐₛₖ₃ 1260c). Each kernel of the plurality of kernels (e.g., kernelₜₐₛₖ₁ 1260a, kernelₜₐₛₖ₂ 1260b, and kernelₜₐₛₖ₃ 1260c) is associated with a respective application (e.g., task).

Each kernel of the plurality of kernels (e.g., kernelₜₐₛₖ₁ 1260a, kernelₜₐₛₖ₂ 1260b, and kernelₜₐₛₖ₃ 1260c) can be applied to the image (e.g., input frame 1 1210) for a respective kernel application (e.g., kernel application 1270a, kernel application 1270b, and kernel application 1270c) to generate output images (e.g., processed-1 1280a and processed-2 1280b).

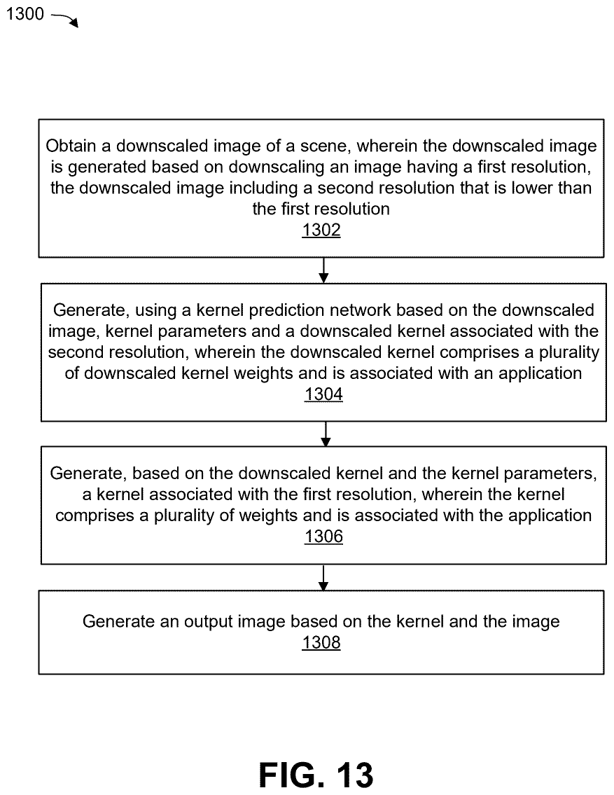

FIG. 13 is a flow chart illustrating an example of a process 1300 for image processing using a context aware spatially varying kernel. The process 1300 can be performed by a computing device (e.g., a computing device or computing system 1400 of FIG. 14) or by a component or system (e.g., a chipset, one or more processors central processing units (CPUs), digital signal processors (DSPs), graphics processing units (GPUs), any combination thereof, and/or other type of processor(s), or other component or system) of the computing device. The operations of the process 1300 may be implemented as software components that are executed and run on one or more processors (e.g., processor 1410 of FIG. 14, or other processor(s)). Further, the transmission and reception of signals by the computing device in the process 1300 may be enabled, for example, by one or more antennas and/or one or more transceivers (e.g., wireless transceiver(s)).

At block 1302, the computing device (or component thereof) can obtain a downscaled image (e.g., downscaled image 540 of FIG. 5 and/or other downscaled image described herein) of a scene. The downscaled image is generated based on downscaling an image having a first resolution. The downscaled image includes a second resolution that is lower than the first resolution. In some aspects, the computing device (or component thereof) can downscale the image to generate the downscaled image. In some cases, the computing device can include a first processor (e.g., a neural signal processor (NSP), a neural processing unit (NPU), a digital signal processor (DSP), etc.) and a second processor (e.g., an image signal processor (ISP), etc.). In such cases, the second processor can downscale the image to generate the downscaled image.

At block 1304, the computing device (or component thereof) can generate, using a kernel prediction network based on the downscaled image (e.g., and in some cases based on context of the scene), kernel parameters and a downscaled kernel associated with the second resolution (e.g., output 560 of FIG. 5, which as described previously can include kernel parameter para for the first resolution and a downscaled kernel K associated with the second resolution). For instance, the downscaled kernel can include a plurality of downscaled kernel weights and is associated with an application (e.g., a denoising application, a sharpening application, a deblurring application, a blurring application, a re-mosaicing application, a de-mosaicing application, or other type of application). As noted previously, in some aspects, the computing device can include a first processor (e.g., an NSP, an NPU, a DSP, etc.) and a second processor (e.g., the ISP, etc.). In such aspects, the first processor can generate the kernel parameters and the downscaled kernel associated with the second resolution. In some aspects, the kernel parameters include a first parameter associated with an order of a size of the kernel and a second parameter associated with a number of coefficients in the downscaled kernel.

At block 1306, the computing device (or component thereof) can generate (e.g., using the second processor, such as the ISP), based on the downscaled kernel and the kernel parameters, a kernel (e.g., the spatially varying kernel 690 of FIG. 6) associated with the first resolution. The kernel includes a plurality of weights and is associated with the application. In some aspects, weights of the plurality of weights of the kernel are spatially varied across the image. In some cases, to generate the kernel (e.g., using the second processor), the computing device (or component thereof) can convolve the downscaled kernel with the second parameter to produce a kernel map (e.g., the kernel map 660 of FIG. 6) associated with the first resolution and can convolve the kernel map with the first parameter.

At block 1308, the computing device (or component thereof) can generate (e.g., using the second processor, such as the ISP) an output image based on the kernel and the image. the output image.

In some aspects, the computing device (or component thereof) can obtain an additional downscaled image (e.g., one or more of the additional downscaled images illustrated in FIG. 6) including the second resolution. The additional downscaled image is generated based on downscaling an additional image having the first resolution. In some cases, the image is captured with a first exposure time and the additional image is captured with a second exposure time different from the first exposure time. In some aspects, image includes a first amount of noise and the additional image includes a second amount of noise different from the first amount of noise. The computing device (or component thereof) can generate, using the kernel prediction network based on the additional downscaled image (e.g., and in some cases based on context of the scene), additional kernel parameters and an additional downscaled kernel (e.g., one or more of the additional downscaled kernel maps 640 shown in FIG. 6) associated with the second resolution. The additional downscaled kernel is associated with the application. The computing device (or component thereof) can generate, based on the additional downscaled kernel and the additional kernel parameters, an additional kernel (e.g., one or more of the spatially varying kernels 690 of FIG. 6, one or more of the kernels 1050a, 1050b, and/or 1050c of FIG. 10, one or more of the kernels 1150a, 1150b, and/or 1150c of FIG. 11, etc.) associated with the first resolution. The additional kernel includes a plurality of additional weights and is associated with the application. In some aspects, the kernel prediction network is a machine learning model. In such aspects, the computing device (or component thereof) can generate (e.g., using the first processor, such as the NSP, NPU, DSP, etc.) using the kernel prediction network, the downscaled kernel and the additional downscaled kernel during a same forward pass of the machine learning model. In some aspects, the computing device (or component thereof) can generate, based on combining the kernel and the additional kernel, a final kernel (e.g., the combined kernel kernel_{combining} 1060 of FIG. 10, the combined kernel kernel_{combining} 1160 of FIG. 11, etc.).

In some aspects, the computing device (or component thereof) can generate, using the kernel prediction network based on the downscaled image (e.g., and in some cases based on context of the scene), additional kernel parameters and an additional downscaled kernel associated with the second resolution. The additional downscaled kernel is associated with an additional application (e.g., one or more of the kernel applications 1270a, 1270b, and/or 1270c of FIG. 12, etc.) that is different than the application. The computing device (or component thereof) can generate, based on the additional downscaled kernel and the additional kernel parameters, an additional kernel (e.g., one or more of the kernels 1260a, 1260b, and/or 1260c of FIG. 12, etc.) associated with the first resolution. The additional kernel includes a plurality of additional weights and is associated with the additional application (e.g., one or more of the kernel applications 1270a, 1270b, and/or 1270c of FIG. 12, etc.). The computing device (or component thereof) can generate an additional output image (e.g., one or more of the kernel applications 1280a and/or 1280b of FIG. 12, etc.) based on the additional kernel and the image.

In some cases, the computing device of process 1300 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the BluetoothTM standard, data according to the Internet Protocol (IP) standard, and/or other types of data.

The components of the computing device of process 1300 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1300 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1300 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 14 is a block diagram illustrating an example of a computing system 1400, which may be employed for image processing using a context aware spatially varying kernel. In particular, FIG. 14 illustrates an example of computing system 1400, which can be for example any computing device making up internal computing system, a remote computing system, a camera, or any component thereof in which the components of the system are in communication with each other using connection 1405. Connection 1405 can be a physical connection using a bus, or a direct connection into processor 1410, such as in a chipset architecture. Connection 1405 can also be a virtual connection, networked connection, or logical connection.

In some aspects, computing system 1400 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1400 includes at least one processing unit (CPU or processor) 1410 and connection 1405 that communicatively couples various system components including system memory 1415, such as read-only memory (ROM) 1418 and random access memory (RAM) 1425 to processor 1410. Computing system 1400 can include a cache 1412 of high-speed memory connected directly with, in close proximity to, or integrated as part of processor 1410.

Processor 1410 can include any general purpose processor and a hardware service or software service, such as services 1432, 1434, and 1436 stored in storage device 1430, configured to control processor 1410 as well as a special-purpose processor where software instructions are incorporated into the actual processor design. Processor 1410 may essentially be a completely self-contained computing system, containing multiple cores or processors, a bus, memory controller, cache, etc. A multi-core processor may be symmetric or asymmetric.

To enable user interaction, computing system 1400 includes an input device 1445, which can represent any number of input mechanisms, such as a microphone for speech, a touch-sensitive screen for gesture or graphical input, keyboard, mouse, motion input, speech, etc. Computing system 1400 can also include output device 1435, which can be one or more of a number of output mechanisms. In some instances, multimodal systems can enable a user to provide multiple types of input/output to communicate with computing system 1400.

Computing system 1400 can include communications interface 1440, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1440 may also include one or more range sensors (e.g., LiDAR sensors, laser range finders, RF radars, ultrasonic sensors, and infrared (IR) sensors) configured to collect data and provide measurements to processor 1410, whereby processor 1410 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1440 may also include one or more receivers or transceivers that are used to determine a location of the computing system 1400 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1430 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1430 can include software services, servers, services, etc., that when the code that defines such software is executed by the processor 1410, it causes the system to perform a function. In some aspects, a hardware service that performs a particular function can include the software component stored in a computer-readable medium in connection with the necessary hardware components, such as processor 1410, connection 1405, output device 1435, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for image processing, the apparatus comprising: at least one memory; and at least one processor coupled to the at least one memory and configured to: obtain a downscaled image of a scene, wherein the downscaled image is generated based on downscaling an image having a first resolution, the downscaled image including a second resolution that is lower than the first resolution; generate, using a kernel prediction network based on the downscaled image, kernel parameters and a downscaled kernel associated with the second resolution, wherein the downscaled kernel comprises a plurality of downscaled kernel weights and is associated with an application; generate, based on the downscaled kernel and the kernel parameters, a kernel associated with the first resolution, wherein the kernel comprises a plurality of weights and is associated with the application; and generate an output image based on the kernel and the image.

Aspect 2. The apparatus of Aspect 1, wherein the at least one processor comprises: a first processor configured to generate the kernel parameters and the downscaled kernel associated with the second resolution; and a second processor configured to generate the kernel associated with the first resolution and the output image.

Aspect 3. The apparatus of Aspect 2, wherein the first processor is a neural signal processor (NSP), a neural processing unit (NPU), or a digital signal processor (DSP).

Aspect 4. The apparatus of any of Aspects 2 or 3, wherein the second processor is an image signal processor (ISP).

Aspect 5. The apparatus of any of Aspects 1 to 4, wherein the kernel parameters comprise a first parameter associated with an order of a size of the kernel and a second parameter associated with a number of coefficients in the downscaled kernel.

Aspect 6. The apparatus of Aspect 5, wherein, to generate the kernel, the at least one processor is configured to: convolve the downscaled kernel with the second parameter to produce a kernel map associated with the first resolution; and convolve the kernel map with the first parameter.

Aspect 7. The apparatus of any of Aspects 1 to 6, wherein the at least one processor is configured to: obtain an additional downscaled image including the second resolution, wherein the additional downscaled image is generated based on downscaling an additional image having the first resolution; generate, using the kernel prediction network based on the additional downscaled image, additional kernel parameters and an additional downscaled kernel associated with the second resolution, and wherein the additional downscaled kernel is associated with the application; and generate, based on the additional downscaled kernel and the additional kernel parameters, an additional kernel associated with the first resolution, wherein the additional kernel comprises a plurality of additional weights and is associated with the application.

Aspect 8. The apparatus of Aspect 7, wherein the application is a denoising application.

Aspect 9. The apparatus of any of Aspects 7 or 8, wherein the kernel prediction network is a machine learning model, and wherein the at least one processor is configured to generate, using the kernel prediction network, the downscaled kernel and the additional downscaled kernel during a same forward pass of the machine learning model.

Aspect 10. The apparatus of any of Aspects 7 to 9, wherein the at least one processor is configured to generate, based on combining the kernel and the additional kernel, a final kernel.

Aspect 11. The apparatus of Aspect 10, wherein the image is captured with a first exposure time and the additional image is captured with a second exposure time different from the first exposure time.

Aspect 12. The apparatus of any of Aspects 10 or 11, wherein the image comprises a first amount of noise and the additional image comprises a second amount of noise different from the first amount of noise.

Aspect 13. The apparatus of any of Aspects 1 to 12, wherein the at least one processor is configured to: generate, using the kernel prediction network based on the downscaled image, additional kernel parameters and an additional downscaled kernel associated with the second resolution, and wherein the additional downscaled kernel is associated with an additional application that is different than the application; generate, based on the additional downscaled kernel and the additional kernel parameters, an additional kernel associated with the first resolution, wherein the additional kernel comprises a plurality of additional weights and is associated with the additional application; and generate an additional output image based on the additional kernel and the image.

Aspect 14. The apparatus of any of Aspects 1 to 13, wherein the plurality of weights of the kernel is spatially varied across the image.

Aspect 15. The apparatus of any of Aspects 1 to 14, wherein the application is denoising, sharpening, deblurring, blurring, re-mosaicing, or de-mosaicing.

Aspect 16. The apparatus of any of Aspects 1 to 15, wherein the at least one processor is configured to downscale the image to generate the downscaled image.

Aspect 17. A method for image processing, the method comprising: obtaining a downscaled image of a scene, wherein the downscaled image is generated based on downscaling an image having a first resolution, the downscaled image including a second resolution that is lower than the first resolution; generating, using a kernel prediction network based on the downscaled image, kernel parameters and a downscaled kernel associated with the second resolution, wherein the downscaled kernel comprises a plurality of downscaled kernel weights and is associated with an application; generating, based on the downscaled kernel and the kernel parameters, a kernel associated with the first resolution, wherein the kernel comprises a plurality of weights and is associated with the application; and generating an output image based on the kernel and the image.

Aspect 18. The method of Aspect 17, wherein the kernel parameters and the downscaled kernel associated with the second resolution are generated using a first processor, and wherein the kernel associated with the first resolution and the output image are generated using a second processor.

Aspect 19. The method of Aspect 18, wherein the first processor is a neural signal processor (NSP), a neural processing unit (NPU), or a digital signal processor (DSP).

Aspect 20. The method of any of Aspects 18 or 19, wherein the second processor is an image signal processor (ISP).

Aspect 21. The method of any of Aspects 18 to 20, wherein a device comprises the first processor and the second processor.

Aspect 22. The method of any of Aspects 17 to 21, wherein the kernel parameters comprise a first parameter associated with an order of a size of the kernel and a second parameter associated with a number of coefficients in the downscaled kernel.

Aspect 23. The method of Aspect 22, wherein the kernel is generated further based on convolving the downscaled kernel with the second parameter to produce a kernel map associated with the first resolution, and based on convolving the kernel map with the first parameter.

Aspect 24. The method of any of Aspects 17 to 23, further comprising: obtaining an additional downscaled image including the second resolution, wherein the additional downscaled image is generated based on downscaling an additional image having the first resolution; generating, using the kernel prediction network based on the additional downscaled image, additional kernel parameters and an additional downscaled kernel associated with the second resolution, and wherein the additional downscaled kernel is associated with the application; and generating, based on the additional downscaled kernel and the additional kernel parameters, an additional kernel associated with the first resolution, wherein the additional kernel comprises a plurality of additional weights and is associated with the application.

Aspect 25. The method of Aspect 24, wherein the application is a denoising application.

Aspect 26. The method of any of Aspects 24 or 25, wherein the kernel prediction network is a machine learning model, and wherein the kernel prediction network generates the downscaled kernel and the additional downscaled kernel during a same forward pass of the machine learning model.

Aspect 27. The method of any of Aspects 24 to 26, further comprises generating, based on combining the kernel and the additional kernel, a final kernel.

Aspect 28. The method of Aspect 27, wherein the image is captured with a first exposure time and the additional image is captured with a second exposure time different from the first exposure time.

Aspect 29. The method of any of Aspects 27 or 28, wherein the image comprises a first amount of noise and the additional image comprises a second amount of noise different from the first amount of noise.

Aspect 30. The method of any of Aspects 17 to 29, further comprising: generating, using the kernel prediction network based on the downscaled image, additional kernel parameters and an additional downscaled kernel associated with the second resolution, and wherein the additional downscaled kernel is associated with an additional application that is different than the application; generating, based on the additional downscaled kernel and the additional kernel parameters, an additional kernel associated with the first resolution, wherein the additional kernel comprises a plurality of additional weights and is associated with the additional application; and generating an additional output image based on the additional kernel and the image.

Aspect 31. The method of any of Aspects 17 to 30, wherein the plurality of weights of the kernel is spatially varied across the image.

Aspect 32. The method of any of Aspects 17 to 31, wherein the application is denoising, sharpening, deblurring, blurring, re-mosaicing, or de-mosaicing.

Aspect 33. The method of any of Aspects 17 to 32, further comprising downscaling the image to generate the downscaled image.

Aspect 34. A non-transitory computer-readable medium having stored thereon instructions that, when executed by at least one processor, cause the at least one processor to perform operations according to any of Aspects 17 to 33.

Aspect 35. An apparatus for image processing, the apparatus including one or more means for performing operations according to any of Aspects 17 to 33.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for image processing, the apparatus comprising:
at least one memory; and
at least one processor coupled to the at least one memory and configured to:
obtain a downscaled image of a scene, wherein the downscaled image is generated based on downscaling an image having a first resolution, the downscaled image including a second resolution that is lower than the first resolution;
generate, using a kernel prediction network based on the downscaled image, kernel parameters and a downscaled kernel associated with the second resolution, wherein the downscaled kernel comprises a plurality of downscaled kernel weights and is associated with an application;
generate, based on the downscaled kernel and the kernel parameters, a kernel associated with the first resolution, wherein the kernel comprises a plurality of weights and is associated with the application; and
generate an output image based on the kernel and the image.

2. The apparatus of claim 1, wherein the at least one processor comprises:
a first processor configured to generate the kernel parameters and the downscaled kernel associated with the second resolution; and
a second processor configured to generate the kernel associated with the first resolution and the output image.

3. The apparatus of claim 2, wherein the first processor is a neural signal processor (NSP), a neural processing unit (NPU), or a digital signal processor (DSP).

4. The apparatus of claim 2, wherein the second processor is an image signal processor (ISP).

5. The apparatus of claim 1, wherein the kernel parameters comprise a first parameter associated with an order of a size of the kernel and a second parameter associated with a number of coefficients in the downscaled kernel.

6. The apparatus of claim 5, wherein, to generate the kernel, the at least one processor is configured to:
convolve the downscaled kernel with the second parameter to produce a kernel map associated with the first resolution; and
convolve the kernel map with the first parameter.

7. The apparatus of claim 1, wherein the at least one processor is configured to:
obtain an additional downscaled image including the second resolution, wherein the additional downscaled image is generated based on downscaling an additional image having the first resolution;
generate, using the kernel prediction network based on the additional downscaled image, additional kernel parameters and an additional downscaled kernel associated with the second resolution, and wherein the additional downscaled kernel is associated with the application; and
generate, based on the additional downscaled kernel and the additional kernel parameters, an additional kernel associated with the first resolution, wherein the additional kernel comprises a plurality of additional weights and is associated with the application.

8. The apparatus of claim 7, wherein the application is a denoising application.

9. The apparatus of claim 7, wherein the kernel prediction network is a machine learning model, and wherein the at least one processor is configured to generate, using the kernel prediction network, the downscaled kernel and the additional downscaled kernel during a same forward pass of the machine learning model.

10. The apparatus of claim 7, wherein the at least one processor is configured to generate, based on combining the kernel and the additional kernel, a final kernel.

11. The apparatus of claim 10, wherein the image is captured with a first exposure time and the additional image is captured with a second exposure time different from the first exposure time.

12. The apparatus of claim 10, wherein the image comprises a first amount of noise and the additional image comprises a second amount of noise different from the first amount of noise.

13. The apparatus of claim 1, wherein the at least one processor is configured to:
generate, using the kernel prediction network based on the downscaled image, additional kernel parameters and an additional downscaled kernel associated with the second resolution, and wherein the additional downscaled kernel is associated with an additional application that is different than the application;
generate, based on the additional downscaled kernel and the additional kernel parameters, an additional kernel associated with the first resolution, wherein the additional kernel comprises a plurality of additional weights and is associated with the additional application; and
generate an additional output image based on the additional kernel and the image.

14. The apparatus of claim 1, wherein the plurality of weights of the kernel is spatially varied across the image.

15. The apparatus of claim 1, wherein the application is denoising, sharpening, deblurring, blurring, re-mosaicing, or de-mosaicing.

16. The apparatus of claim 1, wherein the at least one processor is configured to downscale the image to generate the downscaled image.

17. A method for image processing, the method comprising:
obtaining a downscaled image of a scene, wherein the downscaled image is generated based on downscaling an image having a first resolution, the downscaled image including a second resolution that is lower than the first resolution;
generating, using a kernel prediction network based on the downscaled image, kernel parameters and a downscaled kernel associated with the second resolution, wherein the downscaled kernel comprises a plurality of downscaled kernel weights and is associated with an application;
generating, based on the downscaled kernel and the kernel parameters, a kernel associated with the first resolution, wherein the kernel comprises a plurality of weights and is associated with the application; and
generating an output image based on the kernel and the image.

18. The method of claim 17, wherein the kernel parameters and the downscaled kernel associated with the second resolution are generated using a first processor, and wherein the kernel associated with the first resolution and the output image are generated using a second processor.

19. The method of claim 18, wherein the first processor is a neural signal processor (NSP), a neural processing unit (NPU), or a digital signal processor (DSP), and wherein the second processor is an image signal processor (ISP).

20. The method of claim 17, wherein the kernel parameters comprise a first parameter associated with an order of a size of the kernel and a second parameter associated with a number of coefficients in the downscaled kernel.
